(19) United States
(12) Patent Application Publication
(10) Pub. No.: US 2005/0054350 A1
(43) Pub. Date: Mar. 10, 2005

(54) Real time location system

(76) Inventor: Chris Zegelin, San Jose, CA (US)

Correspondence Address: BAKER & BOTTS, 30 ROCKEFELLER PLAZA, NEW YORK, NY, 10112, US

(21) Appl. No.: 10/648,712

(22) Filed: Aug. 26, 2003

(51) Int. Cl. H04Q 7/20

(52) U.S. Cl. 455/456.1

(57) ABSTRACT

Portable devices are provided with location data determined at a server computer by comparing radio signal characteristics to a database of characteristics. In one arrangement the server additionally downloads a portion of the database of radio signal characteristics to the portable device and the portable device uses the downloaded portion of the data base to determine if its location has changed. The portable device may either update the location data that it has previously downloaded from the server or alternately may signal the server to provide either updated location data or an increased rate of location data update.

### BACKGROUND OF THE INVENTION

This invention relates to real time location systems and in particular to systems wherein portable devices, which are equipped with data communications radios are located using RF signals transmitted between the portable device and fixed devices having known locations. Systems of this type are known, which use data communications protocols, such as IEEE standard 802.11 for wireless data communications. In some systems of this type, the signal strength at the receiver for transmissions between the mobile unit and the fixed devices is measured, either at the portable device or at the fixed devices. Location may be estimated using a database that correlates signal strength within an area to location within the area. Alternately, location can be estimated based on signal strength. The location estimation can be made either by signal strength as received at the fixed devices or the signal strength as received at the mobile device.

In systems wherein such communications protocols are used, items can be located by scanning the identity of an item, such as by scanning a bar code or reading an RFID tag, and knowing the location of the portable device that includes the scanner or RFID tag reader. In such systems location information may take several seconds to be calculated, since it is frequently done at a central computer. Where the location of an object is to be correlated with the location of the portable device, the portable device may have moved between the last update of it's location and the location of the object. Accordingly there can be a latency in the determining location of the item.

It is an objection of the present invention to provide a method and apparatus that determines when a portable device has changed location.

### SUMMARY OF THE INVENTION

In accordance with the invention there is provided an improvement in a system wherein a portable device, arranged for wireless data communications with a computer, is located using radio signals between the portable device and fixed devices. The computer has a database relating radio signal characteristics to location within an area. The computer communicates location data to the portable device using wireless data communication. In accordance with the improvement of the invention, the computer further communicates characteristic data representing radio signal environment in a sub area corresponding to the location data to the portable device. The portable device monitors received radio signals corresponding to the data representing radio signal environment to detect changes in location of the device.

Once it has been determined that the location of a device has moved, a processor on the portable device can use the characteristic data and the radio signals corresponding to radio signal environment to update the location data. Where the device is arranged to transmit location data to a computer in association with other data, the device transmits the updated location data in association with the other data. When is determined that the device has moved the portable device may signal the computer to provide updated location data. Alternately the portable device can signal the computer to provide an increase rate of updated location data.

In accordance with the invention there is provided a portable device arrange to communicate with a computer using wireless data communications. The device includes at least one radio receiver for receiving signals including data communications signals. The device also includes a processor arranged to receive from the radio and store location data and characteristic data representing radio signal environment in a sub area corresponding to the location data. The processor is further arranged to cause the receiver to monitor signals corresponding to the radio signal environment and provide the processor with radio signal data corresponding to the radio signal environment. The processor is arranged to use the radio signal data and the characteristic data representing radio signal environment in a sub area corresponding to the location data to determine if the device has changed location.

The device may also use radio signal data and the characteristic data representing radio signal environment to update the location data. Where the device is arrange to transmit the location data to a computer in association with other data, the device transmits the updated location data in association with the other data. The portable device processor may be arranged to cause the transmitter to send a data message to the computer to cause the computer to update the location data if the device has changed location. Alternately, the processor may cause the transmitter to send a data message to the computer to cause the computer to provide an increased rate of updated location data if the device has changed location.

In accordance with the invention there is provided a system wherein a portable device, arranged for wireless data communications with a computer, is located using radio signals between the portable device and fixed devices. The computer uses a database relating radio signal characteristics to location to compute location of the device and communicate location data to the portable device using wireless data communications. According to the improvement of the invention the portable device monitors received radio signals corresponding to the radio signal characteristics to detect a change in location of the device.

When a change in location is detected, the portable device may signal the computer to provide updated location data. Alternately, the portable device may signal the computer to provide an increase rate of updated location data.

In accordance with the invention there is provided a portable device arranged to communicate with a computer using wireless data communications. The device includes at least one radio for sending and receiving signals including data communications signals. The device further includes a processor arranged to cause the receiver to monitor signals corresponding to radio signal environment, and to provide the processor with radio signal data corresponding to the radio signals. The processor is arranged to used the radio signal data to determine if the device has changed location.

When it is determined that the device has changed location; the device processor may be arranged to cause the transmitter to send a data message to the computer to cause the computer to provide updated location data. Alternately, the processor may cause the transmitter of the unit to send a data message to cause the computer to provide an increased rate of updated location data.

For a better understanding of the present invention, together with other and further objects, reference is made to the following description, taken in conjunction with the accompanying drawings, and its scope will be pointed out in the appended claims.

### BRIEF DESCRIPTION OF THE DRAWINGS

FIG. 1 is a drawing illustrating a system in which the improvement of the present invention may be practiced.

FIG. 2 is a flow diagram illustrating a first method in accordance with a first embodiment of the present invention.

FIG. 3 is a block diagram illustrating a method in accordance with a second embodiment of the present invention.

FIG. 4 is a block diagram illustrating a method in accordance with third embodiment of the present invention.

FIG. 5 is a block diagram illustrating a portable device for practicing the method of the present invention.

### DESCRIPTION OF THE INVENTION

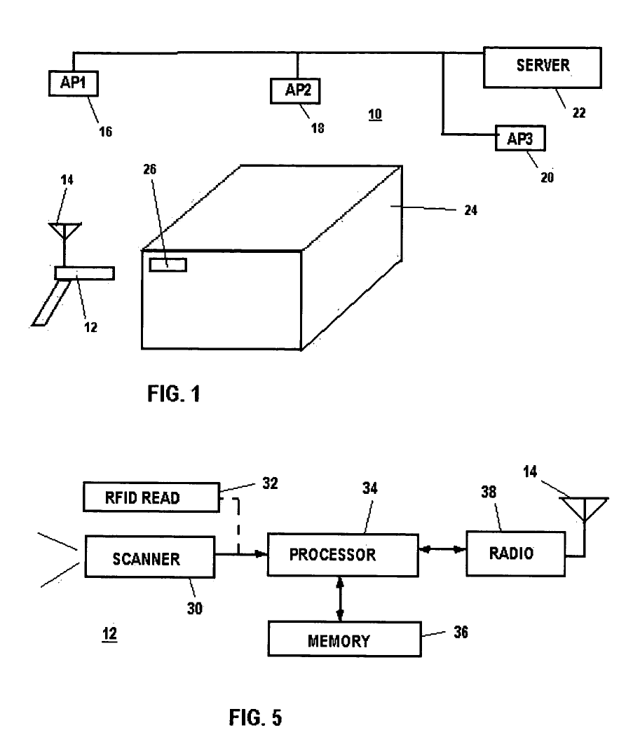

Referring to FIGS. 1 and 6, there is shown a representative system 10 in which the method of the present invention may be practiced. A computer 22 acts as a server for mobile units 12 which communicate with the server through access point 16, 18, and 20. In one arrangement the mobile unit 12 includes a bar code scanner 30, shown in FIG. 5 for scanning a bar code label 26 on a package 24 to be located. Using a built-in radio 38, the processor 34 on the mobile unit 12 caused radio 38, having antenna 14 to transmit the identification read from label 26 along with the location of mobile unit 12 to server 22 using one of access points 16, 18, or 20.

Once this data has been received by the server the location of a package or other item 24 can be determined by determining the location of the mobile unit 12 at the time the label 26 was read by the scanner in mobile unit 12. The location of mobile unit 12 may advantageously be determined by measuring the signal strength at which the mobile unit 12 receives from transmissions from access points 16, 18, and 20. In one arrangement, mobile unit 12 may measure the signal strength, such as by using the RSSI function provided by IEEE Standard 802.11. Data representing the received signal strength from, for example, 3 or 4 access points is transmitted by mobile unit 12 to server 22. Server 22 compares the signal strength data received from the mobile unit to a database which correlates signal strength with location within an area to be monitored, such as a medical facility, a warehouse, a factory or an office. Accordingly, server 22 can record the time, location and identification of item 24.

This type of system can be used to track the location of articles as they move through a facility.

Alternately the access point 16, 18, and 20 may measure the signal strength of signals received from mobile unit 12 and provide such signal strength measurement data to server 22 for determining the location of mobile unit 12.

The present invention is intended to provide a method for improving the latency experienced by the mobile unit 12 when it is moving within a facility.

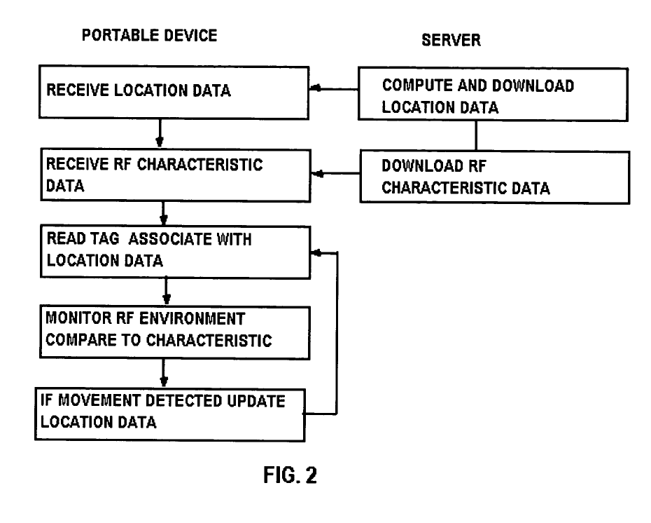

Referring to FIG. 2, there is shown a flow diagram of a first embodiment of the method of the present invention. In accordance with the first embodiment, the computer server 22 determines and downloads location data to the portable device 12 which receives and store data representing its location. In addition, the computer server 22 downloads RF characteristic data which is a portion of the database used by the computer server 22 for determining location of mobile units. The downloaded characteristic data consist of a sub area of the database that corresponds to the region surrounding the location computed for the mobile unit. The RF characteristic data is received and stored at the portable device, for example in memory 36 associated with processor 34, shown in FIG. 6. Thereafter, portable device 12 uses a bar code scanner, or alternately an RFID reader 32 to read a tag associated with an item 24. The identification read from a tag or label is correlated with the location data that has been downloaded to the portable device, and may be communicated to computer server 22 using wireless data communication.

In addition, the processor 34 of portable device 12 causes radio 38 having antenna 14 to monitored the RF environment, for example by measuring the received signal strength of beacon signals sent by access point 16, 18, and 20. The RF environment data measured by processor 34 and radio 38 is compared to the sub area RF characteristic data which has been downloaded. Using this comparison the processor 34 can determine if the portable device 12 has moved from the location corresponding to the location data previously downloaded. If a motion has been detected the location data may be updated by processor 34 and thereafter the updated location data is associated with identification data read from labels or tags thereafter.

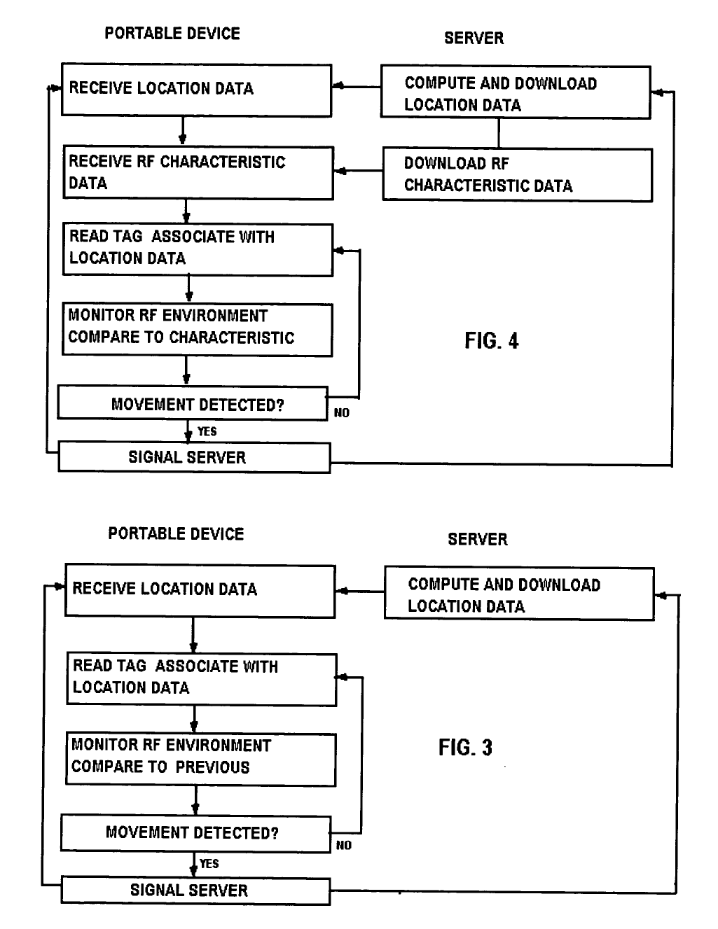

Referring to FIG. 3 there is shown a second embodiment of the method of the present invention. In the embodiment of FIG. 3, location data is downloaded by the server 22 to portable device 12. The location data is associated with data read from tags or labels on item 24. In addition, processor 24 causes radio 38 to monitored the RF environment, again such as the beacon signals received from access point 16, 18, and 20. In the embodiment of FIG. 3, the RF signal strength determined by processor 34 are compared to prior measurements of RF signal strength, either the immediate prior measurement or an average of two or more prior measurements, to determine whether the portable device 12 has moved. When it is determined by processor 34 that the portable device has moved, processor 34 causes radio 38 to signal the server 22 and request updated location data. If it is determined that portable device 12 has not moved, the device continues the process of using the same location data. As an alternate to requesting updated location data, the processor 34 may signal the server 22 to provide location updates at a higher rate, since it is evident from the changed location that the portable device 12 is moving.

Referring to FIG. 4 there is shown a third embodiment of the method of the present invention. In the embodiment of FIG. 4 the determination that the portable device has moved is made using downloaded RF characteristic data. When movement is detected the processor 34 may signal the server 22 to request an updated location data and may also calculate the movement and update the location data itself pending the receipt of new location data from the server 22. Alternately, the processor 34 may signal the server 22 to provide more frequent location data.

While there have been described what are believe to be the preferred embodiments of the invention, those skilled in the art will recognize that other changes and modifications may be made thereto without departing from the spirit of the invention, and it is intended to claim all such changes and modifications as fall within the true scope of the invention.

1. In a system wherein a portable device, arranged for wireless data communications with a computer, is located using radio signals between said portable device and fixed devices, and wherein said computer uses a database relating radio signal characteristics to location to compute location of said device , and communicates location data to said portable device using wireless data communications, the improvement wherein said computer communicates characteristic data representing radio signal environment in a sub-area corresponding to said location data to said portable device, and wherein said portable device monitors received radio signals corresponding to said data representing radio signal environment to detect a change in location of said device.

2. The improvement specified in claim 1 wherein said portable device uses said characteristic data and said radio signals corresponding to said radio signal environment to update said location data.

3. The improvement specified in claim 2 wherein said device is arranged to transmit said location data to a computer in association with other data and wherein said device transmits said updated location data in association with said other data.

4. The improvement specified in claim 1 wherein said portable device signals said computer to provide updated location data if said device determines that it has changed location.

5. The improvement specified in claim 1 wherein said portable device signals said computer to provide an increased rate of updated location data if said device determines that it has moved.

6. A portable device arranged to communicate with a computer using wireless data communications, comprising:
at least one radio receiver for receiving signals including data communications signals; and
a processor arranged to receive from said radio and store location data and characteristic data representing radio signal environment in a sub-area corresponding to said location data, said processor being arranged to cause said receiver to monitor signals corresponding to said radio signal environment and to provide said processor with radio signal data corresponding to said radio signal environment, and said processor being further arranged to use said radio signal data and said characteristic data representing radio signal environment in a sub-area corresponding to said location data to determine if said device has changed location.

7. A portable device as specified in claim 6 wherein said processor is further arranged to use said radio signal data and said characteristic data representing radio signal environment in a sub-area corresponding to said location data to update said location data.

8. A portable device as specified in claim 7 wherein said device is arranged to transmit said location data to a computer in association with other data.

9. A portable device as specified in claim 6 wherein said portable device further includes a transmitter and wherein said processor is arranged to cause said transmitter to send a data message to said computer to cause said computer to update said location data if said device has changed location.

10. A portable device as specified in claim 6 wherein said portable device further includes a transmitter and wherein said processor is arranged to cause said transmitter to send a data message to said computer to cause said computer to provide an increased rate of location data if said device has changed location.

11. In a system wherein a portable device, arranged for wireless data communications with a computer, is located using radio signals between said portable device and fixed devices, and wherein said computer uses a database relating radio signal characteristics to location to compute location of said device, and communicates location data to said portable device using wireless data communications, the improvement wherein said portable device monitors received radio signals and compares received radio signal characteristics to the characteristics of previously received radio signals to detect a change in location of said device.

12. The improvement specified in claim 11 wherein said portable device signals said computer to provide updated location data if said device determines that it has changed location.

13. The improvement specified in claim 11 wherein said portable device signals said computer to provide an increased rate of updated location data if said device determines that it has changed locations.

14. A portable device arranged to communicate with a computer using wireless data communications, comprising:
at least one radio for sending and receiving signals including data communications signals; and
a processor arranged to cause said radio to monitor received radio signals and to provide said processor with radio signal data corresponding to characteristics of said radio signals, and said processor being arranged to compare said radio signal data to previously received radio signal data to determine if said device has changed location.

15. A portable device as specified in claim 14 wherein said portable device further includes a transmitter and wherein said processor is arranged to cause said transmitter to send a data message to said computer to cause said computer to update device location data if said device has changed location.

16. A portable device as specified in claim 14 wherein said portable device further includes a transmitter and wherein said processor is arranged to cause said transmitter to send a data message to said computer to cause said computer to provide an increased rate of updated location data if said device has changed location.
